(19) United States
(12) Patent Application Publication
(10) Pub. No.: US 2017/0292579 A1
(43) Pub. Date: Oct. 12, 2017

(54) SHOCK ABSORBER

(71) Applicant: KYB Corporation, Tokyo (JP)

(72) Inventors: Satoru TAKEO, Gifu (JP); Toshiharu KAWABE, Aichi (JP)

(73) Assignee: KYB Corporation, Tokyo (JP)

(21) Appl. No.: 15/511,381

(22) PCT Filed: Oct. 13, 2015
(86) PCT No.: PCT/JP2015/078944

§ 371 Date: Mar. 15, 2017

(30) Foreign Application Priority Data
Oct. 14, 2014 (JP) 2014-210056

(51) Int. Cl. F16F 9/56; F16F 9/32

(52) U.S. Cl. CPC F16F 9/56; F16F 9/3257; F16F 9/3242; F16F 2230/0041

(57) ABSTRACT

A shock absorber includes a plate and a lock portion. The plate is secured to a distal end side with respect to a nut of a piston rod by crimping the piston rod. The lock portion is disposed on a bottom portion side of a cylinder and locks the plate. The shock absorber is maintained in a contraction state by the plate being locked by the lock portion.

### TECHNICAL FIELD

The present invention relates to a shock absorber.

### BACKGROUND ART

In a shock absorber used for, for example, an automobile, it is known that compressed gas is sealed into a cylinder to, for example, prevent cavitation of operating fluid. Such shock absorber is usually in the most extension state because of a reactive force of the compressed gas.

Meanwhile, in order to improve conveyance efficiency of the shock absorber and work efficiency during installation to, for example, an automobile, there is the need to maintain the shock absorber in a contraction state until the attachment to, for example, the automobile.

The shock absorber described in JP2000-161488A includes a collar portion integrally disposed on a nut for coupling a piston rod to a piston, and is maintained in a contraction state by the collar portion locked by a locking member disposed on a bottom portion of a cylinder.

### SUMMARY OF INVENTION

The above-described shock absorber includes the nuts, which are special-shaped exclusive goods. The nut has the special shape, and thus an assembly facilities are also exclusive goods. This causes a problem that the cost of the shock absorber increases.

It is an object of the present invention to provide a shock absorber that ensures the maintained contraction state while suppressing cost.

According to one aspect of the present invention, a shock absorber includes a cylinder filled with operating fluid, a piston slidably inserted into the cylinder, a piston rod movably inserted into the cylinder, the piston rod penetrating the piston and being coupled to the piston by a nut, a plate secured to a distal end side with respect to the nut of the piston rod by crimping the piston rod, and a lock portion disposed on a bottom portion side of the cylinder, the lock portion being configured to lock the plate, wherein the shock absorber is maintained in a contracted state by the plate being locked by the lock portion.

### BRIEF DESCRIPTION OF DRAWINGS

FIG. 1 is a partial cross-sectional view illustrating a shock absorber according to a first embodiment of the present invention.

FIG. 2 is a diagram illustrating a positional relation between a plate and a locking member when the shock absorber contracts.

FIG. 3 is a diagram illustrating a positional relation between the plate and the locking member when the shock absorber is maintained in a contraction state.

FIG. 4 is a partial cross-sectional view illustrating a shock absorber according to a second embodiment of the present invention.

### DESCRIPTION OF EMBODIMENTS

### First Embodiment

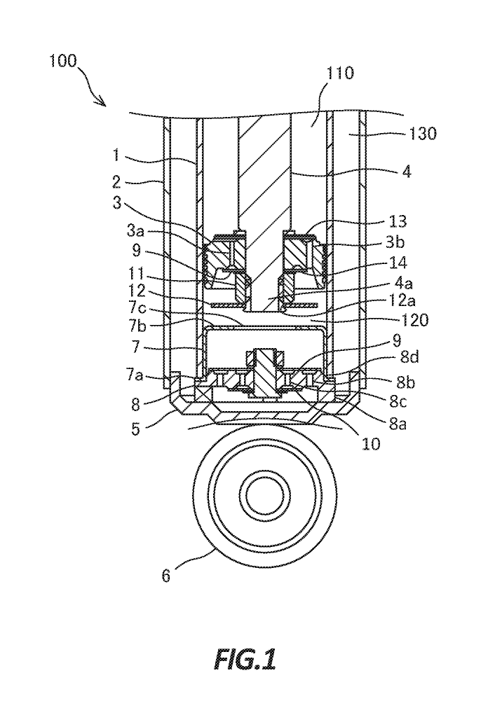

The following describes a shock absorber 100 according to a first embodiment of the present invention with reference to FIG. 1 to FIG. 3.

The shock absorber 100 is interposed between, for example, a vehicle body and an axle shaft of an automobile (not illustrated), and is a device that generates a damping force to reduce vibration of the vehicle body.

As shown in FIG. 1, the shock absorber 100 includes: an inner tube 1 as a cylinder that is filled with hydraulic oil as operating fluid; an outer tube 2 arranged to cover the inner tube 1; a piston 3 that is slidably inserted into the inner tube 1 and partitions an inside of the inner tube 1 into an extension-side chamber 110 and a contraction-side chamber 120; and a piston rod 4 that is inserted to move into and out of the inner tube 1 and is coupled to the piston 3.

Between the inner tube 1 and the outer tube 2, a reservoir 130 that accumulates the hydraulic oil is formed. In the reservoir 130, the hydraulic oil is accumulated, and compressed gas is sealed to prevent cavitation of the operating fluid.

An end portion of the contraction-side chamber 120 side as a bottom portion side of the outer tube 2 is obstructed by a bottom member 5. The bottom member 5 is secured to the outer tube 2 by welding. On the bottom member 5, a coupling member 6 for installing the shock absorber 100 into a vehicle is disposed.

On an end portion of the extension-side chamber 110 side of the inner tube 1, a rod guide (not illustrated) that slidably supports the piston rod 4, and an oil seal (not illustrated) for preventing the hydraulic oil and the compressed gas from leaking outside the shock absorber 100 are disposed. On an end portion of the contraction-side chamber 120 side as a bottom portion side of the inner tube 1, a locking member 7, and a base valve 8 that partitions the contraction-side chamber 120 and the reservoir 130 are disposed.

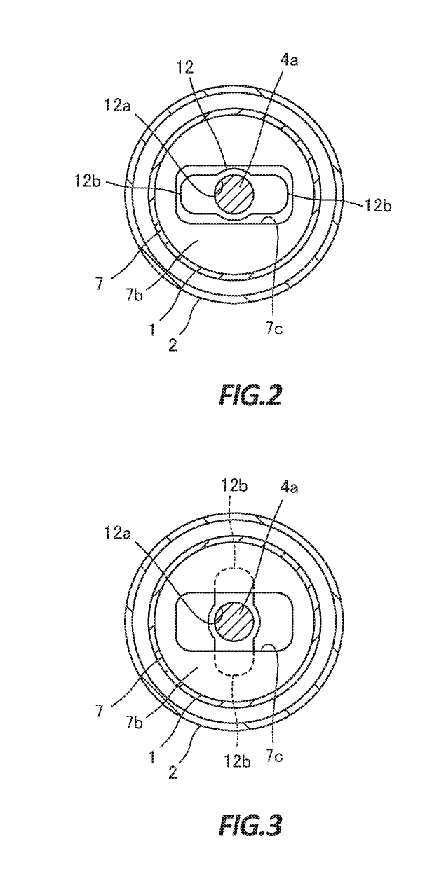

The locking member 7 has a shape of a cylinder with a closed bottom and includes, as shown in FIG. 1, a collar portion 7a formed on an outer peripheral side on an end portion of an opening side, and a slot hole 7c formed on a bottom portion 7b as shown in FIG. 2 and FIG. 3. The locking member 7 can be manufactured with, for example, press forming at low-price. The locking member 7 will be described later.

The base valve 8 includes a plurality of legs 8a formed on an outer peripheral side on a surface on the bottom member 5 side to abut on the bottom member 5, passages 8b and 8c communicating with the contraction-side chamber 120 and the reservoir 130, and a press-fitted portion 8d formed on the outer peripheral side. The base valve 8 is press-fitted to the inner tube 1 via the locking member 7 by the press-fitted portion 8d. As shown in FIG. 1, thus the locking member 7 includes the collar portion 7a sandwiched between an end surface of the contraction-side chamber 120 side of the inner tube 1 and the base valve 8, thus ensuring a secured position in an axial direction.

On the contraction-side chamber 120 side of the base valve 8, a check valve 9 is arranged. On the reservoir 130 side of the base valve 8, a damping valve 10 is arranged.

When the shock absorber 100 extends, a pressure difference between the contraction-side chamber 120 and the reservoir 130 causes the check valve 9 to open to release the passage 8b. When the shock absorber 100 contracts, the check valve 9 obstructs the passage 8b.

When the shock absorber 100 contracts, the pressure difference between the contraction-side chamber 120 and the reservoir 130 causes the damping valve 10 to open to release the passage 8c, so as to provide a resistance to a flow of the hydraulic oil moving from the contraction-side chamber 120 to the reservoir 130 via the passage 8c. When the shock absorber 100 extends, the damping valve 10 obstructs the passage 8c.

On an end portion of the piston 3 side of the piston rod 4, a small-diameter portion 4a is formed. The small-diameter portion 4a has a diameter smaller than an outer diameter of the piston rod 4 and penetrates the piston 3. In the small-diameter portion 4a, an external thread is formed, and the piston rod 4 and the piston 3 are coupled by a nut 11.

On a distal end side with respect to the nut 11 of the piston rod 4, a plate 12 is disposed. As shown in FIG. 2 and FIG. 3, the plate 12 includes a hole 12a disposed at the center, and two collar portions 12b disposed across the hole 12a and extending outward in a radial direction. The plate 12 can be manufactured by, for example, press forming at low-price. As shown in FIG. 1, after the small-diameter portion 4a of the piston rod 4 is inserted into the hole 12a to install the plate 12 into the piston rod 4, the plate 12 is secured to the piston rod 4 by crimping a distal end of the small-diameter portion 4a. The plate 12 will be described later.

The piston 3 includes passages 3a and 3b communicating with the extension-side chamber 110 and the contraction-side chamber 120. On the extension-side chamber 110 side of the piston 3, a damping valve 13 is arranged. On the contraction-side chamber 120 side of the piston 3, a damping valve 14 is arranged.

When the shock absorber 100 contracts, a pressure difference between the extension-side chamber 110 and the contraction-side chamber 120 causes the damping valve 13 to open to release the passage 3b, so as to provide a resistance to a flow of the hydraulic oil moving from the contraction-side chamber 120 to the extension-side chamber 110 via the passage 3b. When the shock absorber 100 extends, the damping valve 13 obstructs the passage 3b.

When the shock absorber 100 extends, the pressure difference between the extension-side chamber 110 and the contraction-side chamber 120 causes the damping valve 14 to open to release the passage 3a, so as to provide a resistance to a flow of the hydraulic oil moving from the extension-side chamber 110 to the contraction-side chamber 120 via the passage 3a. When the shock absorber 100 contracts, the damping valve 14 obstructs the passage 3a.

When the shock absorber 100 extends, in which the piston rod 4 goes out of the inner tube 1, the hydraulic oil moves from the extension-side chamber 110 having a volume reduced by a movement of the piston 3 to the contraction-side chamber 120 having an increased volume via the passage 3a. The hydraulic oil having a volume of the piston rod 4 that has gone out of the inner tube 1 passes through the passage 8b to be supplied to the contraction-side chamber 120 from the reservoir 130.

At this time, as described above, the shock absorber 100 uses the damping valve 14 to provide the resistance to the flow of the hydraulic oil passing through the passage 3a. This generates the pressure difference between the extension-side chamber 110 and the contraction-side chamber 120 to generate a damping force.

When the shock absorber 100 contracts, in which the piston rod 4 enters the inner tube 1, the hydraulic oil moves from the contraction-side chamber 120 having a volume reduced by a movement of the piston 3 to the extension-side chamber 110 having an increased volume via the passage 3b. The hydraulic oil having a volume of the piston rod 4 that has entered the inner tube 1 passes through the passage 8c to be discharged to the reservoir 130 from the contraction-side chamber 120.

At this time, as described above, the shock absorber 100 uses the damping valves 13 and 10 to provide the resistances to the flows of the hydraulic oil passing through the passages 3b and 8c, respectively. This generates the pressure difference between the extension-side chamber 110 and the contraction-side chamber 120 to generate the damping force.

As described above, when the shock absorber 100 extends, the hydraulic oil is supplied to the contraction-side chamber 120 from the reservoir 130. When the shock absorber 100 contracts, the hydraulic oil is discharged to the reservoir 130 from the contraction-side chamber 120. This compensates for a volume change in the inner tube 1.

Subsequently, the following describes operational advantages of the shock absorber 100 having the above-described configuration.

As described above, the shock absorber 100 includes the reservoir 130 into which the compressed gas is sealed. In view of this, a reactive force of the compressed gas causes the piston rod 4 to go out of the inner tube 1. Then, the shock absorber 100 usually becomes the most extension state.

Meanwhile, in order to improve conveyance efficiency of the shock absorber and work efficiency during installation to, for example, an automobile, there is the need to maintain the shock absorber in a contraction state until the attachment to, for example, the automobile.

In regards to this, in the embodiment, the plate 12 and the locking member 7 are provided to maintain the shock absorber 100 in the contraction state while suppressing a cost.

As described above, the plate 12 includes the two collar portions 12b, and the locking member 7 includes the slot hole 7c. As shown in FIG. 2, the slot hole 7c of the locking member 7 is disposed such that the plate 12 passes through the slot hole 7c in a state where the two collar portions 12b of the plate 12 are positioned in a longitudinal direction of the slot hole 7c.

When the shock absorber 100 is maintained in the contraction state, first, the piston rod 4 is rotated, positions of the plate 12, and the slot hole 7c of the locking member 7 are in the state shown in FIG. 2, and then the piston rod 4 is entered into the inner tube 1 until the plate 12 passes through the slot hole 7c of the locking member 7. Then, when the piston rod 4 is rotated, and the positions of the plate 12, and the slot hole 7c of the locking member 7 are in the state shown in FIG. 3, the collar portions 12b of the plate 12 is locked by the bottom portion 7b of the locking member 7. This maintains the shock absorber 100 in the contraction state against the reactive force of the compressed gas.

When the shock absorber 100 is extended, it is only necessary that the piston rod 4 is rotated, and the positions of the plate 12, and the slot hole 7c of the locking member 7 are in the state shown in FIG. 2.

Thus, according to the embodiment, the plate 12 secured to the distal end side with respect to the nut 11 of the piston rod 4 is locked by the bottom portion 7b of the locking member 7. This maintains the shock absorber 100 in the contraction state. The plate 12 and the locking member 7 are components manufacturable with, for example, press forming at low-price. According to this, the structure that maintains the shock absorber in the contraction state is achieved without using an expensive special-shaped component. The plate 12 is secured to the piston rod 4 by crimping the distal end of the small-diameter portion 4a. Even in the case without the plate 12, the crimping of the piston rod 4 is usually performed to prevent the nut 11 from dropping. In view of this, even when the plate 12 is secured to the piston rod 4 by the crimping, an existing facility can be used, and the number of assemblies is not increased. Therefore, the shock absorber that ensures the maintained contraction state is provided while suppressing cost.

### Second Embodiment

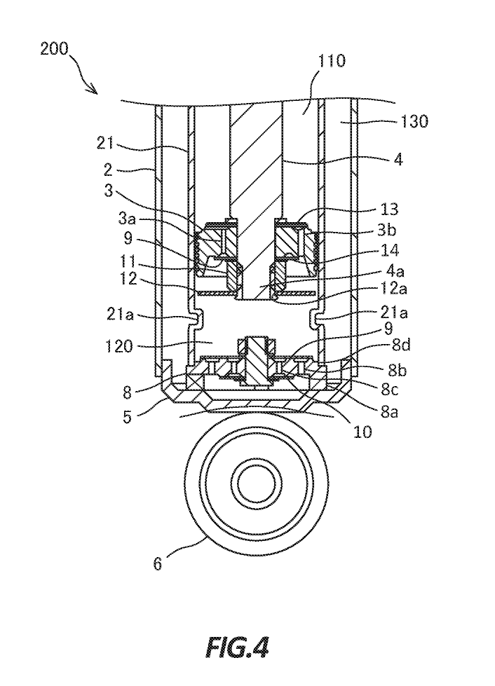

Then, the following describes a shock absorber 200 according to a second embodiment of the present invention with reference to FIG. 4.

In the shock absorber 100 according to the first embodiment, the bottom portion 7b of the locking member 7 is a lock portion that locks the plate 12. In contrast to this, in the shock absorber 200, a convex portion 21a formed projecting toward an inner peripheral side on an inner tube 21 is a lock portion that locks the plate 12 without including the locking member 7. The other configurations are identical to the first embodiment, and thus identical reference numerals are used to omit its description.

According to the embodiment, it is not necessary to further include a component for locking the plate 12. This additionally suppress the cost of the shock absorber that ensures the maintained contraction state.

The following collectively describes configurations, actions, and effects according to the embodiments of the present invention.

In the first embodiment, the shock absorber 100 includes the inner tube 1 filled with the hydraulic oil, the piston 3 slidably inserted into the inner tube 1, the piston rod 4 movably inserted into the inner tube 1, the piston rod 4 penetrating the piston 3 and being coupled to the piston 3 by the nut 11, the plate 12 secured to the distal end side with respect to the nut 11 of the piston rod 4 by crimping the piston rod 4, and the lock portion (the bottom portion 7b) disposed on the bottom portion side of the inner tube 1, the lock portion (the bottom portion 7b) being configured to lock the plate 12. The shock absorber 100 is maintained in a contracted state by the plate 12 being locked by the lock portion (the bottom portion 7b).

In the first embodiment, the lock portion (the bottom portion 7b) is formed on the locking member 7 disposed on the bottom portion side of the inner tube 1.

According to these configurations, the plate 12 secured to the distal end side with respect to the nut 11 of the piston rod 4 is locked by the bottom portion 7b of the locking member 7. This maintains the shock absorber 100 in the contraction state. The plate 12 and the locking member 7 are components manufacturable with, for example, press forming at low-price. According to this, the structure that maintains the shock absorber in the contraction state is achieved without using an expensive special-shaped component. The plate 12 is secured to the piston rod 4 by crimping the distal end of the small-diameter portion 4a. Even in the case without the plate 12, the crimping of the piston rod 4 is usually performed to prevent the nut 11 from dropping. In view of this, even when the plate 12 is secured to the piston rod 4 by the crimping, an existing facility can be used, and the number of assemblies is not increased. Therefore, the shock absorber that ensures the maintained contraction state is provided while suppressing cost.

In the second embodiment, the lock portion (the convex portion 21a) of the shock absorber 200 is formed on the inner tube 21.

According to this configuration, it is not necessary to further include the component for locking the plate 12. This additionally suppress the cost of the shock absorber that ensures the maintained contraction state.

Embodiments of the present invention were described above, but the above embodiments are merely examples of applications of the present invention, and the technical scope of the present invention is not limited to the specific constitutions of the above embodiments.

For example, while in the above-described embodiments the operating fluid is employed as the hydraulic oil, another liquid such as water may be employed.

While in the first embodiment the plate 12 includes the two collar portions 12b, and the locking member 7 includes the slot hole 7c. However, it is only necessary that the plate 12 passes through the hole disposed on the locking member 7 and the bottom portion 7b of the locking member 7 locks the plate 12. This allows employing various shapes as a shape of the plate 12 and a shape the hole of the locking member 7.

With respect to the above description, the contents of application No. 2014-210056, with a filing date of Oct. 14, 2014 in Japan, are incorporated herein by reference.

1. A shock absorber comprising:
a cylinder filled with operating fluid;
a piston slidably inserted into the cylinder;
a piston rod movably inserted into the cylinder, the piston rod penetrating the piston and being coupled to the piston by a nut;
a plate secured to a distal end side with respect to the nut of the piston rod by crimping the piston rod; and
a lock portion disposed on a bottom portion side of the cylinder, the lock portion being configured to lock the plate, wherein
the shock absorber is maintained in a contracted state by the plate being locked by the lock portion.

2. The shock absorber according to claim 1, wherein
the lock portion is formed on a locking member disposed on the bottom portion side of the cylinder.

3. The shock absorber according to claim 1, wherein the lock portion is formed on the cylinder.
